(19) United States
(12) Patent Application Publication
(10) Pub. No.: US 2008/0185932 A1
(43) Pub. Date: Aug. 7, 2008

(54) Tooth Module for a Primary Part, with Permanent-Magnet Excitation, of an Electrical Machine

(75) Inventors: Zeljko Jajtic, Munchen (DE); Gerhard Matscheko, Starnberg (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, 80333 munchen (DE)

(21) Appl. No.: 12/067,889

(22) PCT Filed: Aug. 3, 2006
(86) PCT No.: PCT/EP2006/065003

§ 371 Date: Mar. 24, 2008

(30) Foreign Application Priority Data
Sep. 22, 2005 (DE) 10 2005 045 348.1

(51) Int. Cl. H02K 21/00

(52) U.S. Cl. 310/181

(57) ABSTRACT

The invention relates to a module (1,3,5,7,9) for a primary part (13,15,17) of an electric machine (19, 21) which is excited by a permanent magnet. Said module(1,3,5,7,9) comprises a permanent magnet (23). Said primary part is produced in a simplified manner due to the use of modules (1,3,5,7,9) for constructing a primary part (13,15, 17). The invention relates to a method for producing a wound module (1, 3, 3, 7, 9) in addition to the module, wherein the module (1,3,5,7,9) is reduced in the cross-section thereof in a region (29) of the positioning of a winding (31). The winding is positioned in the region (29) of the positioning of the winding (31) and the cross-section (55) of the module (1,3,5,7,9) is increased in the region (29) of the positioning of the winding (31).

The invention relates to a tooth module of a primary part of an electrical machine with permanent magnet excitation. The electrical machine with permanent magnet excitation is, in particular a synchronous machine. For example, the synchronous machine is in the form of a rotating electrical machine, or else a linear motor. The synchronous machine with permanent magnet excitation has a primary part and a secondary part. The primary part is active, and the secondary part acts passively and, according to the prior art, has permanent magnets.

For many applications for an electrical machine with permanent magnet excitation, a machine such as this often requires a large amount of matching to the respective installation conditions. This relates in particular to direct drives which, for example, may be in the form of a linear motor or a torque motor. The widely differing applications require widely differing model variants of one type of the electrical machine which, for example, must be produced with different dimensions and/or different ratings. Both the technological and technical complexity in particular for manufacture of the electrical machine rises with the wide range of different motor types and sizes in a product range of the electrical machines. Nevertheless, it is not always possible to optimally use an available installation space for the electrical machine, if the electrical machine is in the form of a complete motor. This applies in particular to motors, as well as generators, in which a stator of the electrical machine is manufactured from a laminated blank. This can result in disadvantageously large dimensions of an electrical machine which, for example, would not be necessary just because of the rating. In particular, the relationship between the design and/or rating of the electrical machine and the size of a laminated blank of a stator results in disadvantages with regard to flexibility in the event of changes in the design of the electrical machine, since a change in the laminated blank results in considerable effort. Particularly in the case of linear motors, a large number of different motor sizes are increasingly required, in relatively small batch quantities, in particular with a batch size of 1.

In the case of direct drives, which are in particular synchronous machines with permanent magnet excitation, a plurality of special versions of individual motors are often provided for specific requirements by modifying the entire motor. This modification relates for example to the connection technique, the design configuration or else electromagnetically active parts of the electrical machine.

However, this has the disadvantage that the primary part and secondary part must be redesigned in order in particular to produce a new synchronous machine with permanent magnet excitation which is matched to a new form. Possible forms in this case are, for example, linear motors or rotating motors.

The invention is based on the object of specifying an apparatus in which the design of the electrical machine with permanent magnet excitation is simplified. This relates in particular to a primary part of this machine, and its design.

This object is achieved with an apparatus having the features as claimed in claim 1. The object is also achieved by a primary part having the features as claimed in claim 9. Further solutions also result from a method having the features as claimed in claim 12 or 13. The dependent claims 2 to 8, 10, 11 and 14 are advantageous developments of the claimed subject matters and of the claimed method.

In a tooth module which is intended for formation of a primary part of an electrical machine with permanent magnet excitation, the tooth module is designed such that it has at least one permanent magnet.

The primary part has a plurality of tooth modules, with a plurality of tooth modules being wound. In a further embodiment, the primary part also has unwound tooth modules. Wound and/or unwound tooth modules have at least one permanent magnet. The permanent magnet may be formed integrally or else from a plurality of parts. The tooth modules of the primary part are arranged in one or more rows. This row arrangement results in a circle in a rotating electrical machine. The row arrangement results in the primary part having a linear shape in a linear electrical machine. The electrical machine is, in particular, a synchronous machine which, for example, can be operated as a motor or else as a generator.

According to the invention, the primary part of the electrical machine may be of modular design. The modularity in this case relates in particular to the modular design of that part of the primary part which is used to carry the magnetic flux. This means, for example, that a laminated core of the primary part is of modular design, to be precise by splitting the laminated core into tooth modules. Thus, in one refinement, the tooth module is composed of lamination. In another refinement, the tooth module has no lamination but a monolithic form in which case, for example, a plastic can be used for this purpose, with a soft-magnetic material integrated in it. The modular design allows primary parts of modular construction to be manufactured, for example, for different synchronous machines with permanent magnet excitation. For example, a synchronous machine with permanent magnet excitation can in this way be produced at comparatively low cost and more quickly. The modular design of the primary part from a small number of tooth modules therefore allows a multiplicity of primary parts for machines with permanent magnet excitation to be formed in particular with a secondary part without any permanent magnets. This advantageously reduces the manufacturing costs, as well as the design times for new machines with permanent magnet excitation, in particular with a secondary part without any permanent magnets. The secondary part of the electrical machine with permanent magnet excitation therefore either has no permanent magnets or it is free of permanent magnets at least in places, with the secondary part being formed from a structure composed of iron with teeth which follow one another and point towards the primary part, and with an air gap being located between the primary part and the secondary part. Embodiments of the secondary part are therefore feasible in which permanent magnets are also used in the secondary part, in which case, for example, areas of the secondary part which correspond to one pole pitch angle then remain free of permanent magnets.

The tooth module according to the invention has a tooth end. The tooth end is that part of the tooth which is adjacent to the air gap, that is to say it is opposite the secondary part of the electrical machine in the installed state. In one refinement of the tooth module, the tooth end has a permanent magnet. In consequence, the permanent magnet can be fitted to the tooth module such that it is adjacent to the air gap between the primary part and the secondary part. This has the advantage that the permanent magnet can be fitted easily.

In a further refinement of the tooth module, this tooth module has an area for positioning of a winding. The tooth module may therefore be wound, or a winding can be fitted to the tooth module, for example, by being plugged on. In the area where the winding is located after this, the tooth module advantageously has the permanent magnet. This positioning of the permanent magnet advantageously results in flux concentration.

The tooth module is advantageously waisted in the area for positioning of the winding. A cross section through the tooth module which runs approximately parallel to the air gap when the tooth module is installed in the machine is tapered in the area in which the winding of the tooth module is positioned.

In a further refinement, the tooth module can also be designed such that it has an area for making contact with a further tooth module or a further element of the primary part, with the permanent magnet being positioned in the area in which contact is made. It is advantageous for the permanent magnet of the tooth module itself to be intended to make contact with a further tooth module. The expression making contact means at least making contact between two tooth modules in the magnetic sense. This means that it is not absolutely essential for adjacent contact surfaces to touch mechanically, although this can advantageously be provided.

The permanent magnet of the tooth module may, for example, also be introduced into a retaining groove in the tooth module. The use of a retaining groove which is integrated in the tooth module allows the permanent magnet to be positioned in a simple manner. The retaining groove is advantageously located at least in an area for positioning of the winding. The permanent magnet is at least partially surrounded by the winding of the tooth module in this way. The retaining groove in this case has a longitudinal direction which is approximately at right angles to the air gap.

In a further embodiment of the invention, the tooth module is formed from a plurality of parts, with the tooth module having two or more tooth module parts in the area for positioning of the winding. It is also advantageous, for example, for the tooth module parts to be able to move with respect to one another for positioning of the winding. For example, this makes it possible to reduce the cross section of the tooth module in the area for positioning of the winding and also to enlarge it, for example by reducing or enlarging an intermediate space that is located there. For example, if the intermediate space is reduced, a winding can be plugged onto the tooth, with a permanent magnet subsequently being positioned in the intermediate space.

The tooth module according to the invention can also be upgraded by having an attachment groove. The attachment groove allows the tooth modules to be attached to one another, for example, or allows the tooth module to be attached to an attachment device for a plurality of tooth modules. The attachment groove may be formed by the shape of the laminated blank of the tooth module. In particular, two attachment groove positions can be provided, a side position, and a central position with respect to the tooth module.

A primary part of an electrical machine with permanent magnet excitation can be designed such that it has a plurality of tooth modules. In particular, the electrical machine is a synchronous machine, in which case, for example, synchronous machines may be either in the form of linear motors or torque motors. The primary part has permanent magnets. The tooth modules of the primary part have windings. The electrical machine which has a primary part such as this also has a secondary part which advantageously has no active means for forming a magnetic field. Examples of active means such as these are permanent magnets or windings through which a current can flow.

Since the primary part is formed inter alia from a plurality of tooth modules, it is more easily possible to comply with requirements for flexible matching of an electrical machine, for example to installation requirements. This applies not only to direct drives but also to special motors. The modular design of magnetically active parts of the electrical machine makes it easier to plan and manufacture new motor types and variants. This relates in particular to an electrical machine as is described in the German patent application with the official file reference 10 2004 045 992.4.

Further advantageous refinements are provided by the capability to join the tooth modules together to form a primary part of a segment motor, torque motor or else a ring motor. A segment motor is in this case distinguished by having an annular rotor, with the stator being formed just from segments which, taken together, do not entirely surround the rotor. For example, a segment motor could have two stator segments which, for example, each cover only 30° of the rotor instead of surrounding the rotor over 360° in the rotation direction. In this case, the segments may be formed from primary parts, and the secondary part forms the annular rotor. In contrast, in a ring motor, the rotor and stator are annular. In contrast, a torque motor is distinguished by the torque which is produced on the motor shaft being used without any step-up by a gearbox for the respective application. The secondary part may in general be in the form of an internal rotor or else an external rotor.

In order to form the primary part, the tooth modules in particular have one or more contact surfaces in order to make contact with a further tooth module. This allows the tooth modules to be positioned alongside one another easily, with the magnetic field emerging from a tooth module on the contact surface, and entering the next tooth module.

The tooth modules of the primary part may correspond to the various embodiments of tooth modules as described above, and this also relates to the methods, as described in the following text, for producing a tooth module.

In a first method according to the invention for producing a wound tooth module, the tooth module has a reduced cross section in an area for positioning of a winding. In this case, the cross section of the tooth module relates to a cross section which runs approximately parallel to the air gap of an end-mounted electrical machine. After the reduction in cross section, the winding is positioned in the area for positioning of the winding. This area for positioning advantageously has a waist. After positioning, the cross section of the tooth module can be enlarged again. The enlargement is achieved, for example, by insertion of a permanent magnet or of a magnetic material into a groove in the tooth module. The permanent magnet or the magnetic material can also be inserted into an intermediate space which is formed by two parts of a tooth module, with the intermediate space being at least partially surrounded by the winding.

In a further method according to the invention for producing a tooth module which has a permanent magnet, the tooth module is composed of a material for magnetization. This material for magnetization is a magnetic material which has not yet been magnetized. The tooth module is therefore composed of a magnetic material, in particular located at those positions at which, as described above, the tooth module can have a permanent magnet. According to the invention, the magnetic material of the tooth module is magnetized. It is therefore not magnetized before the permanent magnets are fitted to the tooth module, but together with the tooth module. Since, because of their size, tooth modules can be handled more easily than individual permanent magnets, and since the tooth modules can be magnetized individually or else in groups, this allows a primary part with permanent magnet excitation to be produced more easily. The magnetization of the tooth module in this case always relates to the magnetization of the magnetic material on which the tooth module is composed.

A plurality of tooth module may be held together by various auxiliary apparatuses either only temporarily (that is to say while the motor is being manufactured) or permanently (that is to say as a final assembly solution). This can be done, for example, by
suitable brackets,
shape-matching connecting pieces between two adjacent tooth modules,
positive contour shaping of the contact surfaces of the adjacent tooth modules, and/or by
attraction forces of the permanent magnets inserted in between.

Tooth modules are advantageously attached directly to a load-bearing structure (for example the motor housing), this at the same time also makes it possible to ensure that the electromagnetic drive force of the motor is transmitted.

The invention as well as further advantageous refinements of the invention according to the features of the dependent claims will be explained in more detail in the following text with reference to schematically illustrated exemplary embodiments in the drawing, without this implying any restriction of the invention to these exemplary embodiments. In the FIGS.:

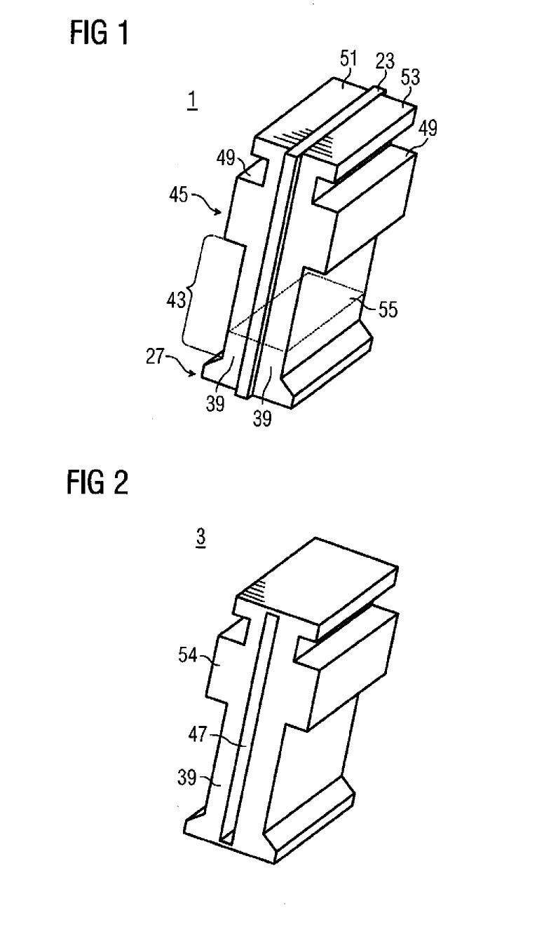

FIG. 1 shows a first tooth module with a centrally arranged permanent magnet,

FIG. 2 shows a further tooth module with a centrally arranged permanent magnet;

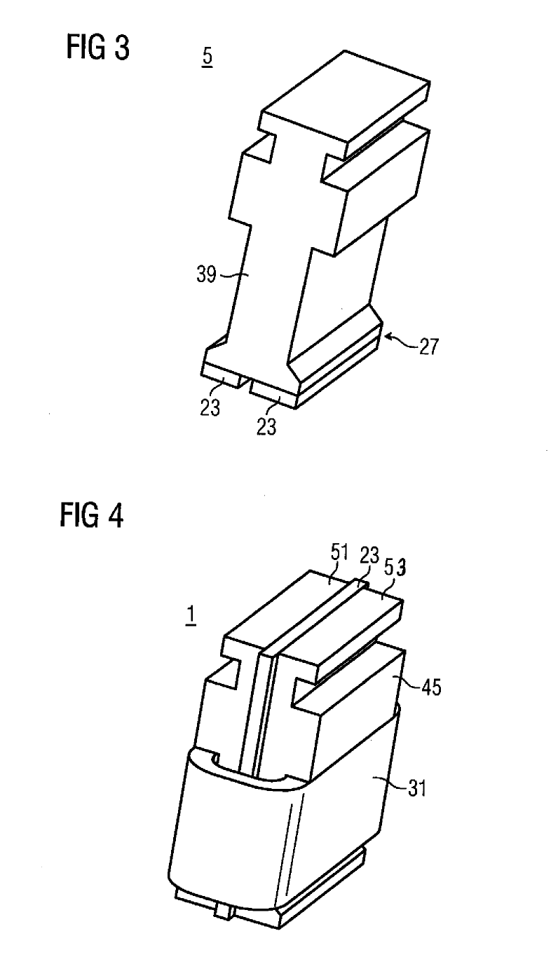

FIG. 3 shows a tooth module with permanent magnets at the tooth end;

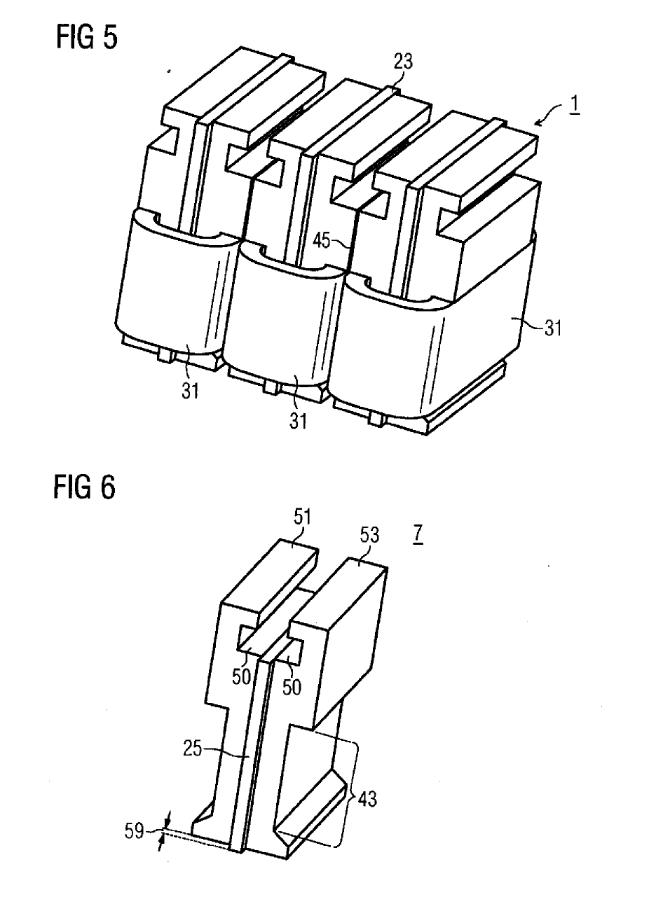

FIG. 4 shows a tooth module with a winding;

FIG. 5 shows tooth modules arranged in a row;

FIG. 6 shows a tooth module with attachment grooves on the inside;

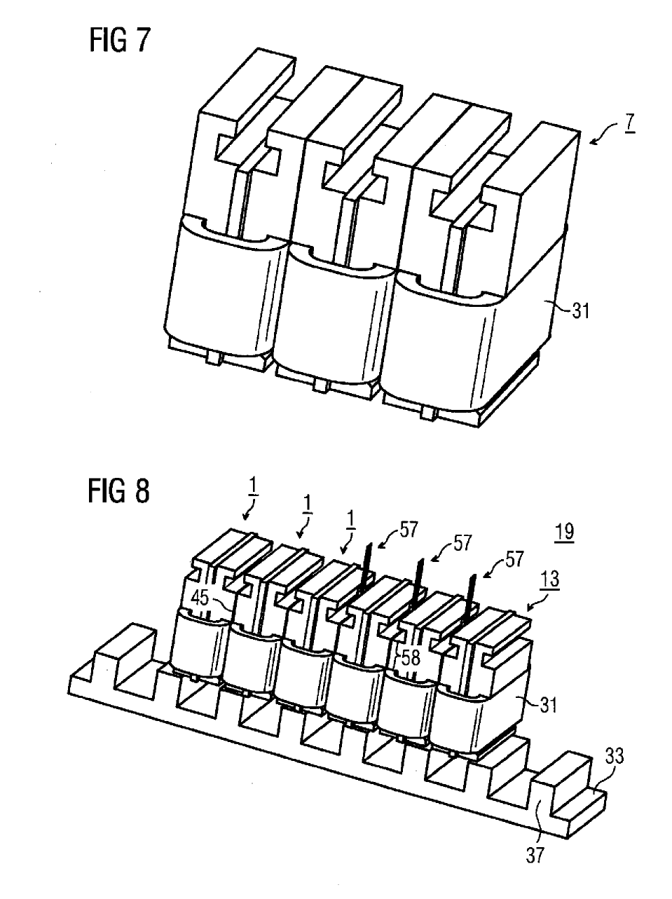

FIG. 7 shows tooth modules from FIG. 6 arranged in a row;

FIG. 8 shows an electrical machine with permanent magnet excitation;

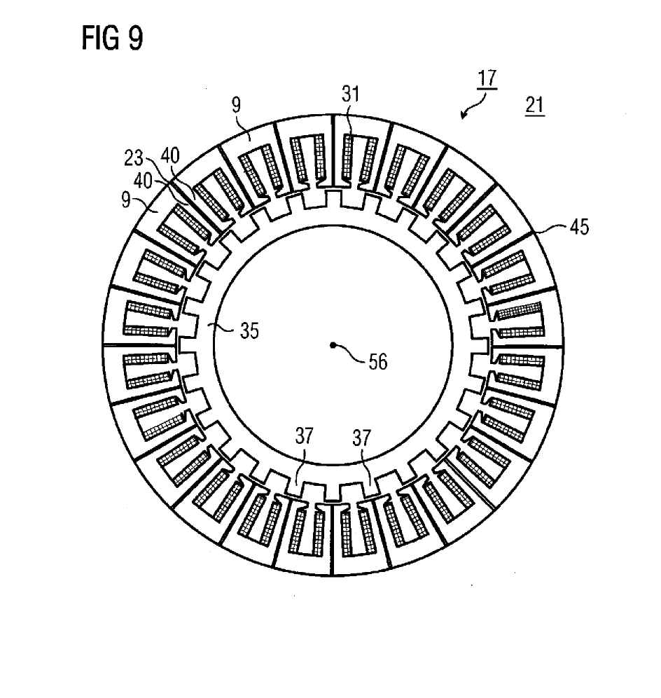

FIG. 9 shows a rotating electrical machine with permanent magnet excitation;

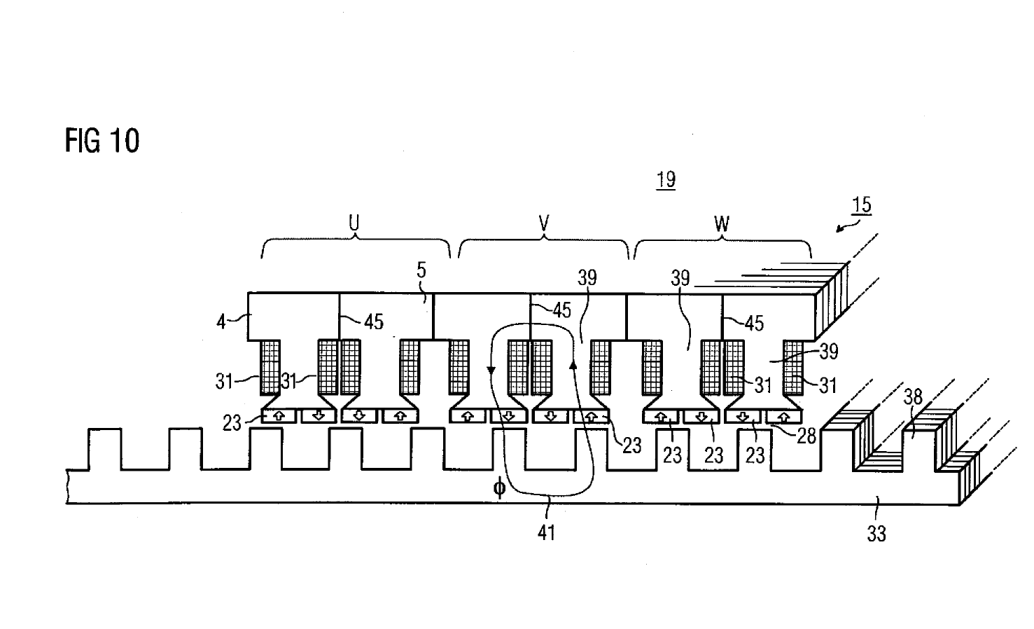

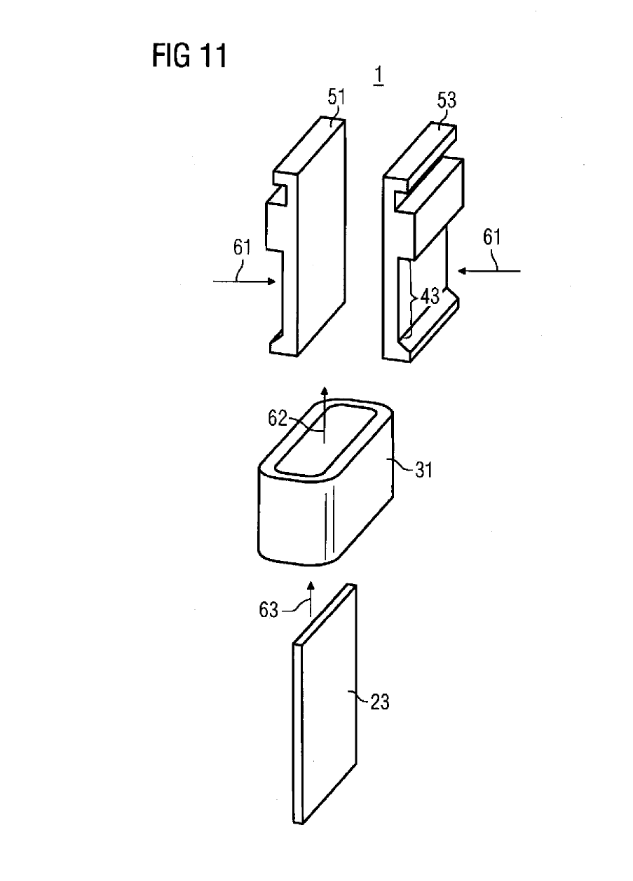

FIG. 10 shows a detail view of a primary part, and

FIG. 11 shows assembly steps for a tooth module.

The illustration in FIG. 1 shows a laminated tooth module 1. The tooth module 1 has a first tooth module part 51 and a second tooth module part 53. Both tooth module parts 51, 53 are laminated. The tooth module parts 51, 53 are used to form a tooth 39. A permanent magnet 23 is located between the two tooth module parts 51 and 53. At the end of the module, the tooth module 1 has a tooth end 27. The end of the module is that part which faces the primary part when the tooth module 1 is used correctly. The tooth end 27 is located opposite a secondary part once the tooth module 1 has been installed correctly. The tooth end 27 is therefore adjacent to an air gap between the primary part and the secondary part. The secondary part is not illustrated in FIG. 1. The tooth module 1 has a waisted area 43. The tooth end 27 is broader than the waisted area 43. The waisted area 43 is located between the end 27 and an area for making contact 45. The area for making contact 45 is intended for making contact with a further tooth module or an intermediate element between two tooth modules, although the intermediate element is not illustrated. Contact making in this case means not only possible mechanical contact being made but also, in particular, contact being made in the magnetic sense for carrying the magnetic flux. A winding 31 can be positioned in the area of the waist 43, although this winding 31 is not illustrated in FIG. 1. By way of example, the winding 31 is illustrated in FIG. 4.

The tooth module 1 has attachment grooves 49 at the end opposite the tooth end 27. By way of example, these attachment grooves 49 are intended for insertion of a groove block which engages both in a first tooth module 1 and in a second tooth module, which are not illustrated in the same way as the groove block in FIG. 1.

When the permanent magnet 23 is fitted in the center between the tooth module parts 51 and 53, this concentrates the flux of the permanent magnet excitation since the vertical cross-sectional area of the permanent magnet 23 (height×depth) is greater than the tooth area 27, aligned with respect to the air gap, of half of the tooth module 51 or 53.

A cross section 55 aligned at right angles to the alignment of the permanent magnet 23 is illustrated in the area of the waist 43. A cross section which would be located in the area of the tooth end 27 is larger than in the area of the waist 43. A corresponding cross section in the area of the contact 45 is also larger than the cross section 55 in the area of the waist 43.

In comparison to FIG. 1, the illustration in FIG. 2 shows a tooth module 3 which has only one tooth module part 54. The tooth module part 54 integrates the tooth module parts 51 and 53 from FIG. 1 in one tooth module part 54. The tooth module part 54 has a retaining groove 47 in the form of a slot for holding a permanent magnet, although this is not illustrated in FIG. 2. In addition to having the tooth module part 54, the tooth module 3 can therefore also have a permanent magnet and, for example, a winding as well, although neither the winding nor the permanent magnet is illustrated in FIG. 2.

In the embodiment variants shown in FIGS. 1 and 2, the tooth module 1, 3 has an internal permanent magnet 23 arranged on edge. The tooth 39 of the tooth module 1 is separated into two halves. This means that the tooth module 1 has at least three split assemblies (two tooth halves 51, 53 and a permanent magnet 23 located between them) which must be joined together. In consequence, motor manufacture is relatively complex and the required tooth geometry is influenced by assembly tolerances. This can have a negative effect on motor characteristic data.

In FIG. 2, the tooth laminate is integral, with the laminated blank having a longitudinal slot in the tooth center. The tooth module parts which are known from FIG. 1, that is to say the tooth halves, are integral in FIG. 2. When the tooth laminates are assembled to form a core, a pocket is formed in the tooth, into which permanent magnets can very easily be inserted. This results in the advantage of simple and fast manufacture and handling of the tooth modules, since the number of assemblies, that is to say the tooth module parts, is reduced. The permanent magnets can be fitted more easily since insertion of a permanent magnet and its permanent fixing in the pocket, for example by adhesive bonding or encapsulation, are additionally assisted by the effect of magnetic forces, if the magnet has already been magnetized. The permanent magnet is not illustrated in FIG. 2. The high accuracy that can be achieved for the tooth geometry, and which is governed only by the stamping accuracy of the tooth laminate, results in better tolerances in the motor characteristic data.

The illustration in FIG. 3 shows a further example of a tooth module 5, which differs from the tooth modules 1 and 3 shown in FIGS. 1 and 2 in that the permanent magnet 23 is arranged at a different location. In FIG. 3, the permanent magnets 23 are located at the tooth end 27. When the tooth module 5 has been installed in an electrical machine, the permanent magnets 23 are therefore adjacent to an air gap and form this together with an opposite secondary part, which is not illustrated in FIG. 3.

The illustration in FIG. 4 shows a tooth module 1 as shown in FIG. 1, with this tooth module 1 having a winding 31. This winding 33 is referred to as a tooth-wound coil since this winding 33 runs around a tooth, with the tooth being formed at least by the waist. As shown in the illustration in FIG. 4, each tooth module part 51, 53 also in this case has an attachment groove. The tooth module parts 51, 53 are, in particular, laminated. The laminated configuration reduces the eddy current losses.

The illustration in FIG. 5 shows tooth modules 1 arranged in a row. The tooth modules 1 make contact in the areas for making contact 45. Arranging the tooth modules 1 in a row allows at least a considerable proportion of the primary part of an electrical machine to be constructed. The electrical machine is, in particular, a synchronous machine, with the primary part in particular being a primary part of a linear synchronous machine. In particular, linear synchronous machines are linear motors.

The illustration in FIG. 6 shows a further tooth module 7 which has tooth module parts 51 and 53, like the tooth module 1 shown in FIG. 1. In contrast to the tooth module shown in FIG. 1, the tooth module in FIG. 6 has attachment grooves 50 which are open towards an inner center of the tooth module 7. The attachment grooves 49 shown in FIG. 1 are open on the outside. This means that the opening of the attachment groove 49 points towards a further tooth module, which is opposite the opposite tooth module during normal use of the tooth module with the tooth modules arranged in a row.

A magnetic material 25 is located between the tooth module parts 51 and 53 and can be magnetized to produce a permanent magnet. The tooth module can therefore be assembled first of all, after which the magnetic material 25 of the tooth module 7 is magnetized, following which the tooth modules 7 are joined together to form a primary part. This method can also be used for permanent magnets of a tooth module in which the intention is to position the permanent magnets differently. At the end, the magnetic material 25 projects beyond the tooth module parts 51 and 53. This projection 59 allows the tooth module 7 to be fitted more easily. This applies in particular to laminated tooth module parts.

The illustration in FIG. 7 shows tooth modules 7, as shown in FIG. 6, arranged in a row. As can also be seen from this illustration, the tooth modules 7 shown in FIG. 6 may also have a winding 31 which is positioned in the area of a waist.

The illustration in FIG. 8 shows an electrical machine 19 with permanent magnet excitation, in the form of a linear motor. The electrical machine 19 with permanent magnet excitation has a secondary part 33 and a primary part 13. The primary part 13 has tooth modules 1 arranged in one or more rows, as shown in FIG. 4. The number of tooth modules 1 may be varied. The area for making contact 45 also advantageously has an installation gap, into which Hall sensors 57 can be inserted. The Hall sensors 57 can be used to measure the magnetic field or the magnetic flux in a yoke area 58 of the primary part 13 and are used, for example, to obtain signals for pole position identification.

In contrast to FIG. 8, which shows a linear motor 19, the illustration in FIG. 9 shows a rotating electrical machine with permanent magnet excitation. Tooth modules 9 are used to form the primary part 17 for the rotating electrical machine 21 with permanent magnet excitation. The tooth modules 9 are designed such that they each form two half teeth 40. The permanent magnet 23 is positioned between the half teeth 40. An entire tooth is in each case formed by arranging the tooth modules 9 in a row. The area 45 for making contact in the primary part 17 shown in FIG. 9 is used firstly to make contact with the permanent magnet 23 and then, subsequently, to make contact with a further tooth module 9. The tooth module 9 has two areas for making contact 45. In linear motors, these areas 45 are arranged such that they result in tooth modules being arranged in a linear row. Since the electrical machine shown in FIG. 9 is a rotating machine, the areas for making contact 45 in the case of the tooth modules 9 are arranged with respect to one another such that they do not run parallel to one another. The planes which are covered by the areas for making contact are at an angle which, for example, is in a range from 1 to 90°. The tooth modules 19 are arranged concentrically around a rotation axis 56. In addition to showing the primary part 17, the illustration in FIG. 9 also shows an associated secondary part 35. The secondary part 35 has teeth 37. The basic design of the secondary part 37 is already known from the design of the secondary part 33, which likewise has teeth 37, as shown in FIG. 8.

The illustration in FIG. 10 shows a further example of an electrical machine 19 with permanent magnet excitation, which has a primary part 15 and a secondary part 33. Both the secondary part 33 and the primary part 15 are laminated. The illustration in FIG. 10 shows a primary part which has tooth modules 5 whose permanent magnets 23 are arranged in the area of the air gap 28. A tooth module as shown in FIG. 10 has a tooth 39. Each tooth has a winding 31. The windings 31 may, for example, be connected to different phases U, V, W.

The illustration in FIG. 11 shows a method for producing a tooth module 1. In this method, the tooth module parts 51 and 53 are joined together as shown by the direction of the arrows, which indicate a first manufacturing step 61. If the tooth module parts 51 and 53 are sufficiently close to one another, a winding 31 can be plugged onto the tooth module parts 51 and 53 in the next step 62, with the positioning being carried out in the area of the waist 43. When the winding 31 is located in the area of the waist 43, then the tooth module parts 51 and 53 are separated from one another in a corresponding manner in the opposite direction to that illustrated by the arrows 61, such that the permanent magnet 23 can be inserted into a gap created in this way, in the next step 63.

The modular design of the electrical machine as described above, by means of tooth modules as a type of building block for the electrical machine, results in advantages, some of which are listed by way of example in the following text:
tooth modules are very highly suitable for manufacturing automation;
the magnet in the wound tooth module can be magnetized easily and completely (this makes it possible to simplify the manufacturing steps, because the permanent magnets are not magnetized until the end of the manufacturing process);
the variable number of tooth modules which are used for the electrical machine allows flexible matching of the motor length to installation conditions for different applications, with little effort;
an installation gap between two adjacent tooth modules allows signals to be obtained easily, by means of a Hall pole position sensor.

1.-14. (canceled)

15. A tooth module for a primary part of an electrical machine with permanent magnet excitation, said tooth module comprising a permanent magnet and being made of a single piece formed with a retaining groove for holding the permanent magnet.

16. The tooth module of claim 15, wherein the tooth module has a receiving area for accepting a winding, said permanent magnet being arranged in the receiving area.

17. The tooth module of claim 15, wherein the receiving area has a waist zone for accepting the winding.

18. The tooth module of claim 15, having an attachment groove for attachment to a further tooth module.

19. A primary part of an electrical machine with permanent magnet excitation, comprising a tooth module including a permanent magnet and being made of a single piece formed with a retaining groove for holding the permanent magnet.

20. The primary part of claim 19 for use in a synchronous machine.

21. The primary part of claim 19, wherein the tooth module has a contact surface for making contact with a further tooth module.

22. A method for producing a tooth module made from a single piece of a magnetizable material, said method comprising the step magnetizing the material to form a permanent magnet.
